(19) United States
(12) Patent Application Publication
(10) Pub. No.: US 2024/0103908 A1
(43) Pub. Date: Mar. 28, 2024

(54) DYNAMIC ADAPTIVE SCHEDULING FOR ENERGY-EFFICIENT HETEROGENEOUS SYSTEMS-ON-CHIP AND RELATED ASPECTS

(71) Applicants: ARIZONA BOARD OF REGENTS ON BEHALF OF ARIZONA STATE UNIVERSITY, Scottsdale, AZ (US); WISCONSIN ALUMNI RESEARCH FOUNDATION, Madison, WI (US); UNIVERSITY OF ARIZONA, Tucson, AZ (US); BOARD OF REGENTS, THE UNIVERSITY OF TEXAS SYSTEM, Austin, TX (US)

(72) Inventors: Chaitali CHAKRABARTI, Tempe, AZ (US); Umit OGRAS, Madison, WI (US); Ahmet GOKSOY, Madison, WI (US); Anish KRISHNAKUMAR, Madison, WI (US); Ali AKOGLU, Tucson, AZ (US); Md Sahil HASSAN, Scottsdale, AZ (US); Radu MARCULESCU, Austin, TX (US); Allen-Jasmin FARCAS, Austin, TX (US)

(73) Assignees: ARIZONA BOARD OF REGENTS ON BEHALF OF ARIZONA STATE UNIVERSITY, Scottsdale, AZ (US); WISCONSIN ALUMNI RESEARCH FOUNDATION, Madison, WI (US); UNIVERSITY OF ARIZONA, Tucson, AZ (US); BOARD OF REGENTS, THE UNIVERSITY OF TEXAS SYSTEM, Austin, TX (US)

(21) Appl. No.: 18/470,177

(22) Filed: Sep. 19, 2023

Related U.S. Application Data
(60) Provisional application No. 63/376,316, filed on Sep. 20, 2022.

(51) Int. Cl. G06F 9/48; G06F 9/54

(52) U.S. Cl. CPC G06F 9/4881; G06F 9/54

(57) ABSTRACT

Provided herein are dynamic adaptive scheduling (DAS) systems. In some embodiments, the DAS systems include a first scheduler, a second scheduler that is slower than the first scheduler, and a runtime preselection classifier that is operably connected to the first scheduler and the second scheduler, which runtime preselection classifier is configured to effect selective use of the first scheduler or the second scheduler to perform a given scheduling task. Related systems, computer readable media, and additional methods are also provided.

### CROSS-REFERENCE TO RELATED APPLICATIONS

This application claims the benefit of U.S. Provisional Application No. 63/376,316 filed Sep. 20, 2022, the disclosure of which is incorporated herein in its entirety.

### STATEMENT OF GOVERNMENT SUPPORT

This invention was made with government support under FA8650-18-2-7860 awarded by the Defense Advanced Research Projects Agency (DARPA). The government has certain rights in the invention.

### FIELD

The present disclosure relates to application task scheduling in computing systems.

### BACKGROUND

Homogeneous multi-core architectures have successfully exploited thread- and data-level parallelism to achieve performance and energy efficiency beyond the limits of single-core processors. While general-purpose computing achieves programming flexibility, it suffers from significant performance and energy efficiency gap when compared to special-purpose solutions. Domain-specific architectures, such as graphics processing units (GPUs) and neural network processors, are recognized as some of the most promising solutions to reduce this gap. Domain-specific systems-on-chip (DSSoCs), a concrete instance of this new architecture, aim at bridging the gap between application-specific integrated circuits (ASICs) and general-purpose processors. Traditional operating system (OS) schedulers can undermine the potential of DSSoCs since their runtime overhead can be orders of magnitude larger than the execution time of the task itself.

Accordingly, there is a need for OS scheduling frameworks that combine the benefits of low- and high-overhead schedulers.

### SUMMARY

The present disclosure provides, in certain aspects, a dynamic adaptive scheduling (DAS) framework that combines the benefits of a fast (low-overhead) scheduler and a slow (sophisticated, high-performance but high-overhead) scheduler. In some embodiments, the present disclosure provides a scheduling methodology targeted towards heterogeneous systems, which can adapt to the desirable scheduling method at runtime in the trade space of scheduling complexity and quality. By adaptively using these schedulers in a complementary manner, DAS not only outperforms both the schedulers individually in terms of scheduling quality but also produces task scheduling decisions with ultra-low overhead, typically in the order of nanoseconds. Obtaining better decisions while simultaneously minimizing the scheduling overhead substantially improves the performance and the energy efficiency in heterogeneous systems-on-chip (SoCs).

In some embodiments, the DAS framework of the present disclosure is implemented in systems that comprise scheduling algorithms including operating system kernels and runtime software environments. Most computing systems such as heterogeneous SoCs, high-performance computing, and embedded devices need fast yet efficient decision-making to minimize the impact of scheduling overheads and maximize system performance. For instance, on the one hand, the execution time of tasks executed on domain-specific heterogeneous SoCs are in the order of nanoseconds, and hence, scheduling overheads must only be a small fraction of it to avoid performance degradation. On the other hand, high-performance computing applications schedule large numbers of tasks in short periods of time, and hence demand low-overhead efficient task scheduling decisions. Accordingly, in some embodiments, DAS is used in the schedulers of such systems, which include operating system kernels and software runtime frameworks. These and other aspects will be apparent upon a complete review of the present disclosure, including the accompanying figures.

According to various embodiments, a dynamic adaptive scheduling (DAS) computing system is presented. The DAS computing system includes a first operating system (OS) scheduler, a second OS scheduler that is slower than the first scheduler, and a runtime preselection classifier that is operably connected to the first scheduler and the second scheduler, which runtime preselection classifier is configured to effect selective use of the first scheduler or the second scheduler to perform a given scheduling task.

Various optional features of the above embodiments include the following. The DAS system outperforms either the first OS scheduler or the second OS scheduler individually when performing the given scheduling task in terms of one or more performance measures selected from the group consisting of: execution time, energy-delay product (EDP), and energy consumption. The DAS computing system achieves an average speedup of at least about 1.2× (e.g., at least about 1.21×, at least about 1.22×, at least about 1.23×, at least about 1.24×, at least about 1.25×, at least about 1.26×, at least about 1.27×, at least about 1.28×, at least about 1.29×, or more) and at least about 30% lower EDP (e.g., at least about 31%, at least about 32%, at least about 33%, at least about 34%, at least about 35%, at least about 36%, at least about 37%, at least about 38%, at least about 39%, or more) relative to the first OS scheduler when a workload complexity increases. The DAS computing system achieves an average speedup of at least about 1.2× (e.g., at least about 1.21×, at least about 1.22×, at least about 1.23×, at least about 1.24×, at least about 1.25×, at least about 1.26×, at least about 1.27×, at least about 1.28×, at least about 1.29×, or more) and at least about 40% lower EDP (e.g., at least about 41%, at least about 42%, at least about 43%, at least about 44%, at least about 45%, at least about 46%, at least about 47%, at least about 48%, at least about 49%, or more) relative to the second OS scheduler at a low data rate. The runtime preselection classifier is configured to dynamically switch between use of the first OS scheduler and the second OS scheduler for the given scheduling task as a function of a state of system resources and/or workload characteristics. The DAS computing system comprises a heterogeneous computing system. The DAS computing system is implemented in a system that comprises scheduling algorithms comprising operating system kernels and a runtime software environment. The DAS computing system or framework is integrated with Compiler-integrated, Extensible DSSoC Runtime (CEDR), an open-source runtime environment. The DAS computing system is trained, deployed, and validated, and evaluated on Xilinx Zynq ZCU102 SoC.

Various additional optional features of the above embodiments include the following. The DAS computing system achieves a scheduling overhead comprising less than about 5 nJ energy (e.g., less than about 4.9 nJ, less than about 4.8 nJ, less than about 4.7 nJ, less than about 4.6 nJ, less than about 4.5 nJ, less than about 4.4 nJ, less than about 4.3 nJ, less than about 4.2 nJ, less than about 4.1 nJ, or lower) and less than about 10 ns runtime (e.g., less than about 9 ns, less than about 8 ns, less than about 7 ns, less than about 6 ns, less than about 5 ns, less than about 4 ns, less than about 3 ns, less than about 2 ns, less than about 1 ns, or lower) for a given medium to low workload and less than about 30 nJ energy (e.g., less than about 29 nJ, less than about 28 nJ, less than about 27 nJ, less than about 26 nJ, less than about 25 nJ, less than about 24 nJ, less than about 23 nJ, less than about 22 nJ, less than about 21 nJ, or lower) and less than about 70 ns runtime (e.g., less than about 69 ns, less than about 68 ns, less than about 67 ns, less than about 66 ns, less than about 65 ns, less than about 64 ns, less than about 63 ns, less than about 62 ns, less than about 61 ns, or lower) for a given heavy workload. The DAS computing system comprises a processor and a memory communicatively coupled to the processor, the memory storing non-transitory computer executable instructions which, when executed by the processor, perform operations comprising: using the runtime preselection classifier to effect the selective use of the first scheduler or the second scheduler to perform the given scheduling task. The runtime preselection classifier is configured to effect use of the first scheduler or the second scheduler to perform the given scheduling task based upon one or more workload characteristics that are selected from the group consisting of: a function of application arrival rate, a number of application instances being processed, and a number of scheduling tasks present in a ready queue. The first scheduler comprises a scheduling overhead having less than about 10 nJ energy and less than about 10 nanoseconds of runtime. The second scheduler comprises a scheduling overhead having more than about 10 nJ energy and more than about 10 nanoseconds of runtime. The DAS computing system comprises a heterogeneous systems-on-chip (SoCs), a high-performance computing system, and/or an embedded device. The heterogeneous SoC comprises a domain-specific SoC (DSSoCs).

According to various embodiments, a method of scheduling a runtime task in a heterogeneous multi-core computing system is presented. The method comprises using a runtime preselection classifier of the heterogeneous multi-core computing system to effect selective use of a first scheduler or a second scheduler that is slower than the first scheduler to perform a given scheduling task, thereby scheduling the runtime task in the heterogeneous multi-core computing system.

Various optional features of the above embodiments include the following. The runtime preselection classifier is configured to effect use of the first scheduler or the second scheduler to perform the given scheduling task based upon one or more workload characteristics that are selected from the group consisting of: a function of application arrival rate, a number of application instances being processed, and a number of scheduling tasks present in a ready queue. The first scheduler comprises a scheduling overhead having less than about 10 nJ energy and less than about 10 nanoseconds of runtime. The second scheduler comprises a scheduling overhead having more than about 10 nJ energy and more than about 10 nanoseconds of runtime. The method comprises generating an oracle, selecting one or more features, and training a model for the runtime preselection classifier.

According to various embodiments, a computer readable media is presented. The computer readable media comprises non-transitory computer executable instructions which, when executed by at least one electronic processor, perform at least: using a runtime preselection classifier to effect selective use of a first scheduler or a second scheduler that is slower than the first scheduler to perform a given scheduling task in a DAS computing system.

### DRAWINGS

The above and/or other aspects and advantages will become more apparent and more readily appreciated from the following detailed description of examples, taken in conjunction with the accompanying drawings, in which:

FIG. 1 is a flowchart describing the flow of a dynamic adaptive scheduling (DAS) framework according to an exemplary embodiment disclosed herein: Oracle generation, feature selection, and training a model for the classifier.

FIGS. 2A-2F are plots showing the comparison of average execution time (A-C) and EDP (D-F) between DAS, LUT, ETF, and ETF-ideal for three different workloads.

FIG. 3 show decisions taken by a DAS framework as bar plots and total scheduling energy overheads of LUT, ETF, and DAS as line plots.

FIG. 4 is a block diagram of a computer system 100 suitable for implementing DAS according to an exemplary embodiment disclosed herein.

### DESCRIPTION OF THE EMBODIMENTS

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or related aspects of the present disclosure.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Domain-specific systems-on-chip (DSSoCs) aim at bridging the gap between application-specific integrated circuits (ASICs) and general-purpose processors. Traditional operating system (OS) schedulers can undermine the potential of DSSoCs since their runtime overhead can be orders of magnitude larger than the execution time of the task itself. To address this problem, the present disclosure provides a dynamic adaptive scheduling (DAS) framework that combines the benefits of a fast (low-overhead) scheduler and a slow (sophisticated, high-performance but high-overhead) scheduler. The goal of DAS is to outperform the execution time and EDP of both types of schedulers by dynamically switching between them as a function of the state of system resources and workload characteristics. To this end, DAS runs a lightweight preselection classifier that determines if the fast or slow scheduler should be used for the next task ready for scheduling, where workload characteristic is represented as a function of application arrival rate, number of applications instances that are being processed and number of tasks that are in the ready queue. Experiments with five real-world streaming applications show that DAS consistently outperforms both the fast and slow schedulers. More precisely, for 40 different workloads, DAS achieves on average 1.29× speedup and 45% lower EDP compared to the sophisticated scheduler at low data rates, and 1.28× speedup and 37% lower EDP than the fast scheduler when the workload complexity increases.

### I. Introduction

Heterogeneous systems-on-chip (SoCs), such as Samsung Exynos and Nvidia® Xavier™, combine the flexibility benefits of general-purpose cores with the energy efficiency and performance of custom designs. An emerging example is domain-specific SoCs, which integrate hardware accelerators targeting the commonly encountered tasks (i.e., computational kernels) in the target domain.

DSSoCs present a new challenge to the classical scheduling problem due to their specialized pipelines that run domain-specific tasks in the order of nanoseconds, i.e., orders of magnitude faster than general-purpose cores. Hence, achieving high performance with DSSoCs requires task scheduling algorithms that can execute in the order of nanoseconds. Fast and low-overhead scheduling is an effective way to minimizing performance and energy consumption overheads. However, while enabling fast decision-making, simple schedulers can make poor scheduling decisions, especially under heavy workloads.

At low data rates, a low-overhead (fast) scheduler outperforms a more sophisticated scheduler due to the simplicity of the scheduling problem. The number of concurrent tasks and the complexity of scheduling decisions grow with the data rate (heavy workload). Consequently, the overhead of making better decisions pays off, i.e., the sophisticated scheduler starts outperforming the simple one. Hence, there is an opportunity to exploit the tradeoff between the scheduling overhead and decision quality.

Accordingly, the present disclosure provides, in some aspects, a dynamic adaptive scheduling (DAS) framework that combines the benefits of both worlds, i.e., a simple scheduler with fast decision making and a sophisticated scheduler with high-quality scheduling decisions through an integrated decision support mechanism. Making a scheduling decision at the scale of nanoseconds is highly challenging since it requires a scheduler to load the relevant feature data and execute possibly complex decision criteria at the scale of nanoseconds. The following key observations enable us to design the DAS framework that outperforms both types of schedulers taken separately: First, the scheduling is not an ordinary process that may be called in the future with some probability. Instead, it will be called with 100% certainty and use a subset of available performance counters, i.e., features used for scheduling. Hence, a background process prefetches the relevant features and writes them to a preallocated local memory location. Second, the same process can also determine whether a simple or a sophisticated scheduler with a higher overhead would perform better. If the lookup table (LUT) is preferred as the simple scheduler, the only extra delay on the critical path is the time it takes to access the LUT, which is 6 ns measured on Arm Cortex-A53. In some embodiments, the sophisticated scheduler is run only if a complex decision is required at runtime. In some of these embodiments, for example, the low scheduling overhead of a simple scheduler and the decision quality of a sophisticated scheduler are combined based on the system workload using a runtime preselection classifier to choose between simple and sophisticated schedulers at runtime and thus enable nanosecond-scale overhead.

Exemplary contributions of this disclosure are as follows:
DAS framework that dynamically combines two schedulers and outperforms each of them taken separately;
Low scheduling overhead: for example, 4.2 nJ energy and 6 ns runtime for low to medium loads; 27.2 nJ energy and 65 ns runtime for heavy workloads in some embodiments;
Experimental results with five streaming applications and profiling of scheduling overheads on a Xilinx Zynq ZCU102.

### II. Dynamic Adaptive Scheduling Framework

### A. Overview and Preliminaries

In some aspects, the present disclosure considers streaming applications that can be modeled by a data flow graph (DFG). Consecutive data frames are pipelined through the tasks in the graph. Unlike the current practice, which is limited to a single scheduler, DAS allows the OS to choose one scheduling policy TT ϵπₛ={F, S}, where F and S refer to the fast and slow (or sophisticated) schedulers, respectively. Once the predecessors of a task are completed, the OS can call either a fast (π=F) or a slow scheduler (π=s) as a function of the system state and workload. The OS collects a set of performance counters during the workload execution to enable two aspects for the DAS framework: (1) precise assessment of the system state, (2) desirable features for the classifier to dynamically switch between the fast and slow schedulers.

Table I presents the performance counters collected by DAS. For a DSSoC with 19 PEs, it uses 62 performance counters. The goal of the fast scheduler F is to approach the theoretically minimum (i.e., zero) scheduling overhead by making decisions in a few cycles with a minimum number of operations. In contrast, the slow scheduler S aims to handle more complex scenarios when the task wait times dominate the execution times. The goal of DAS is to outperform the optimization metrics (execution time and EDP) of both underlying schedulers by dynamically switching between them as a function of system state and workload.

TABLE I
Type of performance counters used by DAS framework

| Type | Features |
|---|---|
| Task | Task ID, Execution time, Power consumption, |
| | Depth of task in DFG, Application ID, |
| | Predecessor task ID and cluster IDs, Application type |
| Processing | Earliest time when PE is ready to execute, |
| Element | Earliest availability time of each cluster, |
| (PE) | PE utilization, Communication cost |
| System | Input data rate |

### B. Zero-Delay DAS Preselection Classifier

The first step of DAS is selecting the fast or slow scheduler. Since this decision is on the critical path of the fast scheduler, it needs to be optimized to approach the zero-overhead goal. One of the novel contributions of DAS is recognizing this selection as a deterministic task that will eventually be executed with probability one. Hence, we prefetch the relevant features required for this decision to a pre-allocated local register. To minimize the overhead, we re-use a subset of the performance counters shown in Table I to make this decision, discussed in Section III-B.

The OS periodically refreshes the performance counters to reflect the current system state. Each time the features are refreshed, DAS runs a lightweight classifier that determines if the fast or slow scheduler should be used for the next ready task. This decision will always be up to date since it is refreshed with the features that reflect the most recent system state. This way, DAS determines which scheduler should be called even before a task is ready for scheduling. Hence, the preselection classifier introduces zero latency and minimal energy overhead, as described next.

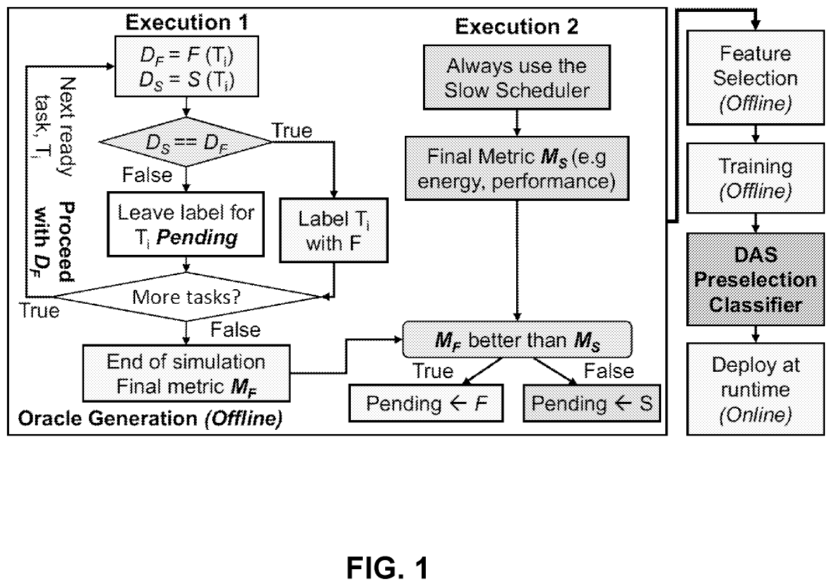

Offline Classifier Design: The first step to design the preselection classifier is generating the training data based on the domain applications known at design time. Each scenario in the training data consists of concurrent applications and their respective data rates (e.g., a combination of WiFi transmitter and receiver chains, at a specific upload and download speed). To this end, we run each scenario twice, as described in FIG. 1.

First Execution: The instrumentation enables us to run both fast and slow schedulers each time a task scheduling decision is made. If the decisions of the fast (D_{F}) and slow (D_{S}) schedulers for a task Tᵢ are identical, then we label task Tᵢ with F (i.e., the fast scheduler) and store a snapshot of the performance counters. If the schedulers return different decisions, then the label is left as pending, and the execution continues by following the fast scheduler's decision, as illustrated in FIG. 1. At the end of the first execution, the training data contains a mixture of both labeled (F) and pending decisions.

Second Execution: The same scenario is executed, this time by always following the slow scheduler's decisions. At the end of the execution, we analyze the target metric, such as the average execution time and energy-delay product. If the slow scheduler achieves a better result, the pending labels are replaced with S to indicate that the slow scheduler is preferred despite its larger overhead. Otherwise, we conclude that the fast scheduler's lower overhead pays off and replace the pending labels with F. An alternative to replacing all pending labels at once is evaluating each decision individually. However, this approach will not be scalable since the scheduling decision at time tₖ affects not only the immediate action but also all the remaining execution flow.

The training data is generated using 40 different workloads. Each workload is a mix of multiple instances of five applications, consisting of approximately 140,000 tasks in total and executed at 14 different data rates (Section III-A). A higher data rate presents a larger number of concurrent applications contending for the same SoC resources. Then, we design a low-overhead classifier using machine learning techniques and feature selection methods, as described in Section III-B and shown in FIG. 1.

Online Use of the Classifier: At runtime, a background process periodically updates a pre-allocated local memory with a small subset of performance counters required by the classifier. After each update, the classifier determines whether the fast F or slow S scheduler should be used for the next available task. When a new ready task becomes available, the features are already loaded, and we know which scheduler is a better choice. Therefore, DAS does not incur any extra delay on the critical path. Moreover, it has a negligible energy overhead, as demonstrated in Section III.

Algorithm 1: ETF Scheduler

| 1 | while ready queue [symbol] is not empty do | | | |
|---|---|---|---|---|
| 2 | \| | for task Tᵢ ∈ [symbol] do | | |
| 3 | \| | \| | for PE pⱼ ∈ [symbol] / * [symbol] = set of PEs */ | |
| 4 | \| | \| | do | |
| 5 | \| | \| | \| | FT_{T}_{_{i,pj}}= Compute the finish time of Tᵢ on pⱼ |

| | | | |
|---|---|---|---|
| 6 | \| | \| | end |

| | | |
|---|---|---|
| 7 | \| | end |
| 8 | \| | (T′, p′) = Find the task & PE pair that has the minimum FT |
| 9 | \| | Assign task T′ to PE p′ |

| | |
|---|---|
| 10 | end |

### C. Fast & Slow (Sophisticated) (F&S) Schedulers

The DAS framework can work with any choice of fast and slow scheduling algorithms. This work uses a LUT implementation as the fast scheduler since the goal of the fast scheduler is to achieve almost zero overhead. The LUT stores the most energy-efficient processor in the target system for each known task in the target domain. Unknown tasks are mapped to the next available CPU core. Hence, the only extra delay on the critical path and overhead is the LUT access. To profile the scheduling overhead, we developed an optimized C implementation with inline assembly code. Experiments show that our fast scheduler takes ˜7.2 cycles (6 ns on Arm Cortex-A53 at 1.2 GHz) on average and incurs negligible (2.3 nJ) energy overhead.

The DAS framework uses a commonly used heuristic, earliest task first (ETF), as the slow scheduler. ETF is chosen since it performs a comprehensive search to make a decision when the SoC is loaded with many tasks. It recursively iterates over the ready tasks and processors to find the schedule with the fastest finish time, as shown in Algorithm 1. Hence, its computational complexity is quadratic on the number of ready tasks.

### III. Experimental Results

### A. Experimental Setup

Domain Applications: The DAS framework is evaluated using five real-world streaming applications: range detection, temporal mitigation, WiFi-transmitter, WiFi-receiver applications, and a proprietary industrial application (App-1). We construct 40 different workloads by mixing applications in different ratios for our evaluations.

Emulation Environment: One of our key goals in this study is to conduct a realistic energy and runtime overhead analysis. For this purpose, we leverage an open-source Linux-based emulation framework. For our analysis, we incorporate LUT and ETF schedulers into this emulation environment. We generate a wide range of workloads—ranging from all application instances belonging to a single application to a uniform distribution from all five applications. We measure the trend between the number of tasks ready to be scheduled and the scheduling overhead of ETF on the Xilinx Zynq ZCU102. Based on these measurements, we generate a quadratic equation to formulate the ETF scheduling overhead. Later, we utilize this equation to evaluate the average execution time and the EDP of the DAS scheduler.

Simulation Environment: We use DS3, an open-source domain-specific system-on-chip simulation framework, for the detailed evaluation of DAS. DS3 includes built-in scheduling algorithms, models for PEs, interconnect, and memory systems. The framework has been validated with Xilinx Zynq ZCU102 and Odroid-XU3 platforms.

DSSoC Configuration: We construct a DSSoC configuration that comprises clusters of general-purpose cores and hardware accelerators. The application domains used in this study are wireless communications and radar systems. The DSSoC used in our experiments uses the Arm big.LITTLE architecture with 4 cores each. We also include dedicated accelerators for fast Fourier transform (FFT), forward error correction (FEC), finite impulse response (FIR), and a systolic array processor (SAP). We include 4 cores each for the FFT and FIR accelerators, one core for the FEC, and two cores of the SAP. The FEC accelerates the execution of encoder and decoder operations. In total, the DSSoC integrates 19 PEs with a mesh-based network-on-chip to enable efficient on-chip data movement.

### B. Exploration of Machine Learning Techniques and Feature Space for DAS

Machine Learning Technique Exploration: We explore different classifiers to co-optimize the classification accuracy and model size towards our minimal overhead goal. Specifically, we investigated support vector classifiers, decision tree (DT), multi-layer perceptron (MLP), and logistic regression (LR). The training process with support vector classifiers with simple kernels exceeded 24 hours, rendering it infeasible. The latency and storage requirements of the MLP (one hidden layer and 16 neurons) did not fit the budgets of low-overhead requirements. Therefore, these two techniques are excluded from the rest of the analysis. Table II summarizes the classification accuracy and storage overheads for the LR and DT classifiers as a function of the number of features. DTs achieve similar or higher accuracies compared to LR classifiers with lower storage overheads. While a DT with depth 16 that uses all features achieves the best classification accuracy, there is a significant impact on the storage overhead, which in turn influences the latency and energy consumption of the classifier. In comparison, DTs with depth 2 and 4 have negligible storage overheads with competitive accuracies (>85%). Hence, for the DAS framework, we adopt the DT classifier with depth 2.

Feature Space Exploration: We collect 62 performance counters in our training data. A systematic feature space exploration is performed using feature selection and importance methods. Among the top six features, growing the feature list from a single feature (input data rate) to two features with the addition of the earliest availability time of the Arm big cluster increases the accuracy from 63.66% to 85.48%. The data rate is tracked at runtime by an 8-entry×16-bit shift register. Therefore, we utilize only two most important features to design a DT of depth 2 for the DAS classifier model; this takes 13 ns to execute on Arm Cortex-A53 cores running at 1.2 GHz.

TABLE II
Classification accuracies and storage overhead of DAS models
with different machine learning classifiers and features

| | Tree | Number of | Classification | Storage |
|---|---|---|---|---|
| Classifier | Depth | Features | Accuracy (%) | (KB) |
| LR | — | 2 | 79.23 | 0.01 |
| LR | — | 62 | 83.1 | 0.24 |
| DT | 2 | 1 | 63.66 | 0.01 |
| DT | 2 | 2 | 85.48 | 0.01 |
| DT | 4 | 6 | 85.51 | 0.03 |
| DT | 16 | 62 | 91.65 | 256 |

### C. Performance and Scheduling Overhead Analysis

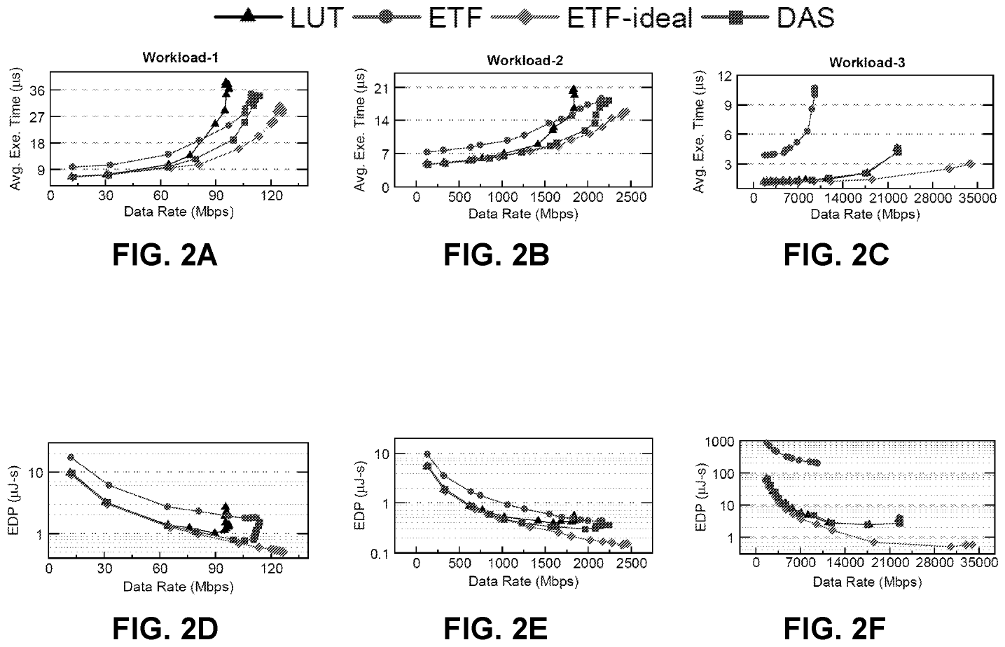

This section compares the DAS framework with LUT (fast), ETF (slow), and ETF-ideal schedulers. ETF-ideal is a version of the ETF scheduler which ignores the scheduling overhead. It helps us establish the theoretical limit of achievable execution time and EDP. Out of the 40 workloads described in Section II-B, we choose three representative workloads for a detailed analysis of execution time and EDP trends. These workloads present different data rates, which are a function of the applications in the workload. Workload-1 (FIGS. 2A,D) presents low data rate, workload-2 (FIGS. 2B,E) presents moderate data rates, and workload-3 (FIGS. 2C,F) represents a high data rate workload.

FIGS. 2A-C (FIGS. 2D-F) compare the execution times (EDP) of DAS, LUT, ETF, and ETF-ideal. For workloads 1 and 2, the SoC is not congested at low data rates. Hence, DAS performs similar to LUT. As data rates increase, DAS aptly chooses between LUT and ETF at runtime. Its execution time and EDP is 14% and 15% lower than LUT, and 15% and 42% lower than ETF. For workload-3, the execution time and EDP of ETF are significantly higher than LUT. DAS chooses LUT for >99% of the decisions and closely follows its execution time and EDP.

This exemplary analysis is extended to all 40 workloads. At low data rates, DAS achieves 1.29× speedup and 45% lower EDP compared to ETF, and 1.28× speedup and 37% lower EDP than LUT, when the workload complexity increases. In summary, DAS consistently performs better than either one of the underlying schedulers, successfully adapts to the workloads at runtime, and aptly chooses between LUT and ETF to achieve low execution time and EDP.

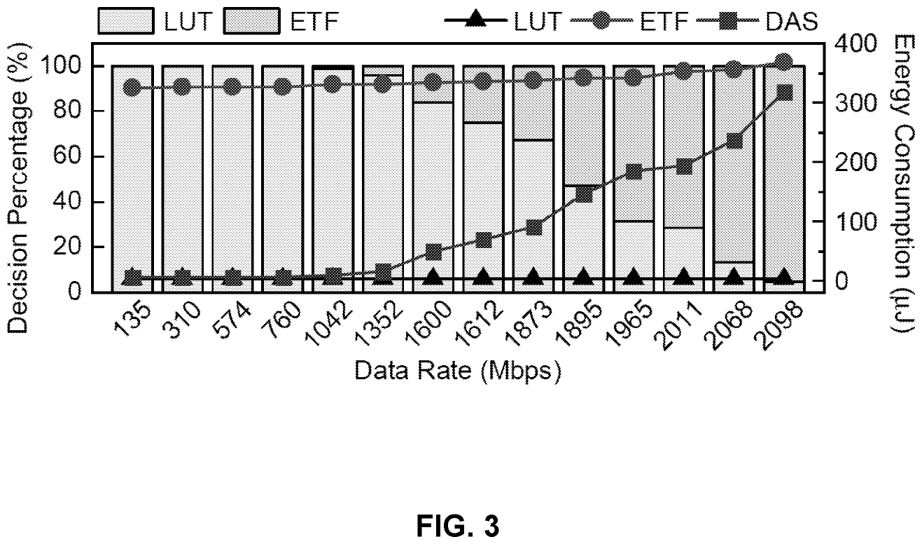

The left axis of FIG. 3 plots the decision distribution of DAS. It uses LUT for all decisions at the lowest data rate and ETF for 95% of decisions at the highest data rate. At a moderate workload of 1352 Mbps, DAS still uses LUT for 96% of the decisions. The secondary axis of FIG. 3 shows the energy overhead of using different schedulers. As DAS uses LUT and ETF based on the system load, its energy consumption varies from that of LUT to ETF. The average scheduling latency overhead of DAS under heavy workloads is 65 ns, and the energy overhead is 27.2 nJ.

We also compared DAS against a heuristic that chooses the fast scheduler when the data rate is less than a predetermined threshold and uses the slow scheduler otherwise. The threshold is chosen judiciously by analyzing the training data used for DAS. Simulation results show that the heuristic closely follows LUT (fast) and ETF (slow) schedulers below and above the data rate threshold, respectively. In contrast, DAS consistently outperforms both schedulers and achieves on average 13% lower execution time than the heuristic across all data rates.

Accordingly, in some aspects, the present disclosure provides a dynamic adaptive scheduling framework that combines the benefits of fast and sophisticated schedulers for heterogeneous SoCs. In some embodiments, DAS achieves an overhead that is as low as 6 ns (4.2 nJ) for a wide range of workload scenarios and on average, 65 ns (27.2 nJ) for heavy workloads for wireless communication and radar system applications. Hence, the exemplary embodiments disclosed herein pave the way for DSSoCs to leverage their potential better to, for example, enable peak performance and energy-efficiency of domain applications.

### IV. Computer System

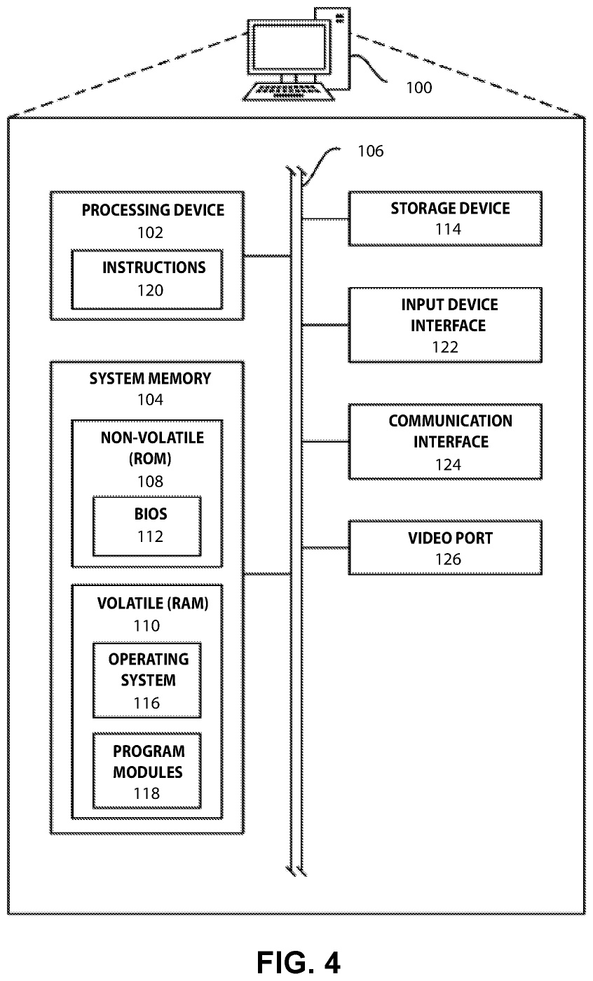

FIG. 4 is a block diagram of a computer system 100 suitable for implementing dynamic adaptive scheduling (DAS) according to embodiments disclosed herein. Embodiments described herein can include or be implemented as the computer system 100, which comprises any computing or electronic device capable of including firmware, hardware, and/or executing software instructions that could be used to perform any of the methods or functions described herein. In this regard, the computer system 100 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 100 in this embodiment includes a processing device 102 or processor, a system memory 104, and a system bus 106. The system memory 104 may include non-volatile memory 108 and volatile memory 110. The non-volatile memory 108 may include read-only memory (ROM), erasable programmable read-only memory (EPROM), electrically erasable programmable read-only memory (EEPROM), and the like. The volatile memory 110 generally includes random-access memory (RAM) (e.g., dynamic random-access memory (DRAM), such as synchronous DRAM (SDRAM)). A basic input/output system (BIOS) 112 may be stored in the nonvolatile memory 108 and can include the basic routines that help to transfer information between elements within the computer system 100.

The system bus 106 provides an interface for system components including, but not limited to, the system memory 104 and the processing device 102. The system bus 106 may be any of several types of bus structures that may further interconnect to a memory bus (with or without a memory controller), a peripheral bus, and/or a local bus using any of a variety of commercially available bus architectures.

The processing device 102 represents one or more commercially available or proprietary general-purpose processing devices, such as a microprocessor, central processing unit (CPU), or the like. More particularly, the processing device 102 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 102 is configured to execute processing logic instructions for performing the operations and steps discussed herein.

In this regard, the various illustrative logical blocks, modules, and circuits described in connection with the embodiments disclosed herein may be implemented or performed with the processing device 102, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 102 may be a microprocessor, or may be any conventional processor, controller, microcontroller, or state machine. The processing device 102 may also be implemented as a combination of computing devices (e.g., a combination of a DSP and a microprocessor, a plurality of microprocessors, one or more microprocessors in conjunction with a DSP core, or any other such configuration).

The computer system 100 may further include or be coupled to a non-transitory computer-readable storage medium, such as a storage device 114, which may represent an internal or external hard disk drive (HDD), flash memory, or the like. The storage device 114 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 116 and any number of program modules 118 or other applications can be stored in the volatile memory 110, wherein the program modules 118 represent a wide array of computer-executable instructions corresponding to programs, applications, functions, and the like that may implement the functionality described herein in whole or in part, such as through instructions 120 on the processing device 102. The program modules 118 may also reside on the storage mechanism provided by the storage device 114. As such, all or a portion of the functionality described herein may be implemented as a computer program product stored on a transitory or non-transitory computer-usable or computer-readable storage medium, such as the storage device 114, volatile memory 110, non-volatile memory 108, instructions 120, and the like. The computer program product includes complex programming instructions, such as complex computer-readable program code, to cause the processing device 102 to carry out the steps necessary to implement the functions described herein.

An operator, such as the user, may also be able to enter one or more configuration commands to the computer system 100 through a keyboard, a pointing device such as a mouse, or a touch-sensitive surface, such as the display device, via an input device interface 122 or remotely through a web interface, terminal program, or the like via a communication interface 124. The communication interface 124 may be wired or wireless and facilitate communications with any number of devices via a communications network in a direct or indirect fashion. An output device, such as a display device, can be coupled to the system bus 106 and driven by a video port 126. Additional inputs and outputs to the computer system 100 may be provided through the system bus 106 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A dynamic adaptive scheduling (DAS) computing system, comprising:
a first operating system (OS) scheduler;
a second OS scheduler that is slower than the first OS scheduler; and;
a runtime preselection classifier that is operably connected to the first scheduler and the second scheduler, which runtime preselection classifier is configured to effect selective use of the first scheduler or the second scheduler to perform a given scheduling task.

2. The DAS computing system of claim 1, wherein the DAS system outperforms either the first OS scheduler or the second OS scheduler individually when performing the given scheduling task in terms of one or more performance measures selected from the group consisting of: execution time, energy-delay product (EDP), and energy consumption.

3. The DAS computing system of claim 1, wherein the DAS computing system achieves an average speedup of at least about 1.2× and at least about 30% lower EDP relative to the first OS scheduler when a workload complexity increases.

4. The DAS computing system of claim 1, wherein the DAS computing system achieves an average speedup of at least about 1.2× and at least about 40% lower EDP relative to the second OS scheduler at a low data rate.

5. The DAS computing system of claim 1, wherein the runtime preselection classifier is configured to dynamically switch between use of the first OS scheduler and the second OS scheduler for the given scheduling task as a function of a state of system resources and/or workload characteristics.

6. The DAS computing system of claim 1, wherein the DAS computing system comprises a heterogeneous computing system.

7. The DAS computing system of claim 1, wherein the DAS computing system is implemented in a system that comprises scheduling algorithms comprising operating system kernels and a runtime software environment.

8. The DAS computing system of claim 1, wherein the DAS computing system achieves a scheduling overhead comprising less than about 5 nJ energy and less than about 10 ns runtime for a given medium to low workload and less than about 30 nJ energy and less than about 70 ns runtime for a given heavy workload.

9. The DAS computing system of claim 1, wherein the DAS computing system comprises a processor and a memory communicatively coupled to the processor, the memory storing non-transitory computer executable instructions which, when executed by the processor, perform operations comprising: using the runtime preselection classifier to effect the selective use of the first scheduler or the second scheduler to perform the given scheduling task.

10. The DAS computing system of claim 1, wherein the runtime preselection classifier is configured to effect use of the first scheduler or the second scheduler to perform the given scheduling task based upon one or more workload characteristics that are selected from the group consisting of: a function of application arrival rate, a number of application instances being processed, and a number of scheduling tasks present in a ready queue.

11. The DAS computing system of claim 1, wherein the first scheduler comprises a scheduling overhead having less than about 10 nJ energy and less than about 10 nanoseconds of runtime.

12. The DAS computing system of claim 1, wherein the second scheduler comprises a scheduling overhead having more than about 10 nJ energy and more than about 10 nanoseconds of runtime.

13. The DAS computing system of claim 1, wherein the DAS computing system comprises a heterogeneous systems-on-chip (SoCs), a high-performance computing system, and/or an embedded device.

14. The DAS computing system of claim 13 wherein the heterogeneous SoC comprises a domain-specific SoC (DSSoCs).

15. A method of scheduling a runtime task in a heterogeneous multi-core computing system, the method comprising using a runtime preselection classifier of the heterogeneous multi-core computing system to effect selective use of a first scheduler or a second scheduler that is slower than the first scheduler to perform a given scheduling task, thereby scheduling the runtime task in the heterogeneous multi-core computing system.

16. The method of claim 15, wherein the runtime preselection classifier is configured to effect use of the first scheduler or the second scheduler to perform the given scheduling task based upon one or more workload characteristics that are selected from the group consisting of: a function of application arrival rate, a number of application instances being processed, and a number of scheduling tasks present in a ready queue.

17. The method of claim 15, wherein the first scheduler comprises a scheduling overhead having less than about 10 nJ energy and less than about 10 nanoseconds of runtime.

18. The method of claim 15, wherein the second scheduler comprises a scheduling overhead having more than about 10 nJ energy and more than about 10 nanoseconds of runtime.

19. The method of claim 15, wherein the method comprises:
generating an oracle;
selecting one or more features; and,
training a model for the runtime preselection classifier.

20. A computer readable media comprising non-transitory computer executable instructions which, when executed by at least one electronic processor, perform at least: using a runtime preselection classifier to effect selective use of a first scheduler or a second scheduler that is slower than the first scheduler to perform a given scheduling task in a DAS computing system.
